(19) United States
(12) Patent Application Publication
(10) Pub. No.: US 2016/0166114 A1
(43) Pub. Date: Jun. 16, 2016

(54) BOWL FOR WASHING AND DISPLAYING FRUIT OR VEGETABLE

(71) Applicants: Nguyet T. Tran, Milpitas, CA (US); Loc Vinh, Milpitas, CA (US)

(72) Inventors: Nguyet T. Tran, Milpitas, CA (US); Loc Vinh, Milpitas, CA (US)

(21) Appl. No.: 14/569,762

(22) Filed: Dec. 14, 2014

(51) Int. Cl. A47J 43/24; A23L 1/01; B65D 25/28; B65D 25/20; B65D 25/04

(52) U.S. Cl. CPC A47J 43/24; B65D 25/205; B65D 25/04; B65D 25/2802; A23L 1/0121; B65D 2525/283; A23V 2002/00

(57) ABSTRACT

A fruit or vegetable cleaning device comprising a lid and a bowl. The bowl has a plurality of vertical blades dividing the bowl into a plurality of chambers, each blade having a plurality of circular opening near the center of the bowl and elongated openings proximal to a bowl wall; and the bowl having openings on a part of a bowl edge and said lid having a recessed edge with opening thereon, said lid recessed edge adapted to be inserted into said bowl edge, said lid recessed edge openings and said bowl edge openings having a first mode exclusive of each other to form a leak proof enclosure to shake the fruit or vegetable and a second mode inclusive of each other to allow liquid to be drained away from said bowl; and a circular screen positioned below said vertical blades.

This invention relates to a fruit cleaning device.

Research has shown that eating lots of fresh produce reduces the risk of some cancers and other diseases. Health agencies and doctors encourage people to eat more fruits and vegetables as a part of their normal diet. This is good for public health. Scientists have found that vegetables and fruit are healthy food to human beings. Fruit are even healthier because of containing high vitamins which is good to maintain a healthy body. On the other hand, news reports have linked Salmonella and E. coli outbreaks with alfalfa and other sprouts. Fruits and vegetables are often eaten raw, without cooking to destroy pathogens. Thus they are potential sources of food-borne illness.

Since most of the fruit are either laid on the ground or exposed on the tree trunk during the growing season, they may be contaminated dirty objects and/or insecticides and require to be washed thoroughly. With the recent food-borne outbreaks related to produce, consumers, more than ever, have heightened concerns over the safety of fresh produce.

Many consumers believe that peering off the skin of fruit is good enough instead of washing in advance. But they have not pay any attention of their hands have touched the skin that will carry germs to the fruit and get sick. Washing fruits and vegetables is the best way to reduce a person's risks for food-borne illness.

### SUMMARY

In one aspect, a raw material cleaning device has a manually operated agitator wherein a container has apertures to permit passage of foreign particles, which are rinsed off, in association with water while restraining the passage of the raw material such as fruit or vegetable.

In another aspect, a fruit or vegetable cleaning device comprising a lid and a bowl. The bowl has a plurality of vertical blades dividing the bowl into a plurality of chambers, each blade having a plurality of circular opening near the center of the bowl and elongated openings proximal to a bowl wall; and the bowl having openings on a part of a bowl edge and said lid having a recessed edge with opening thereon, said lid recessed edge adapted to be inserted into said bowl edge, said lid recessed edge openings and said bowl edge openings having a first mode exclusive of each other to form a leak proof enclosure to shake the fruit or vegetable and a second mode inclusive of each other to allow liquid to be drained away from said bowl; and a circular screen positioned below said vertical blades.

In implementations, the device (lid and bowl) could be circular, oval, square or rectangular in shape and can be made in different sizes. The device is made of a material that can be microwave safe and/or dishwasher safe. The material of the device can handle the heat produced in the microwave or the dishwasher, or the possible agitation of being knocked against the other dishes and the racks.

Advantages of the system may include one or more of the following. The system is portable and suitable for in-home cleaning of vegetable or fruit to simplify the daily works for consumers. The system minimizes hand contacts with the washed fruit or vegetable so that guests can feel safe in eating the fruit. The home appliance is compact in size and easy in operation and maintenance. The cleaning device can clean fruit without requiring electricity or chemical cleansers. The cleaning device has pleasing appearance that can be used directly to display fruits at a formal dinner, for example.

### BRIEF DESCRIPTION OF THE DRAWINGS

FIG. 1 shows an exploded perspective view of a food washing system.

FIG. 2 shows an exploded side view of a food washing system.

FIG. 3 shows an exploded top view of a food washing system.

FIG. 4 shows an exemplary perforated bottom screen.

FIG. 5 shows an exemplary bowl chamber divider or separator with a removable bowl on top.

FIG. 6 shows an exemplary see-through food washing system.

### DESCRIPTION

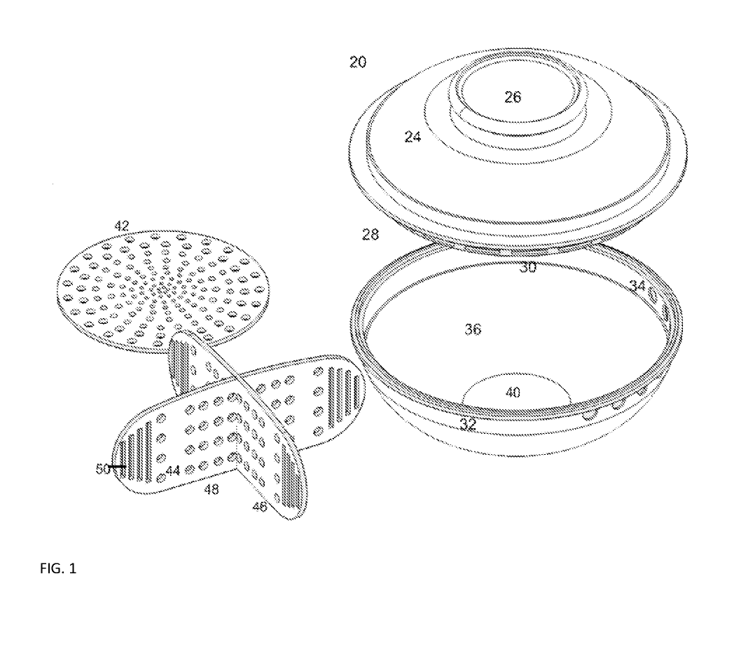

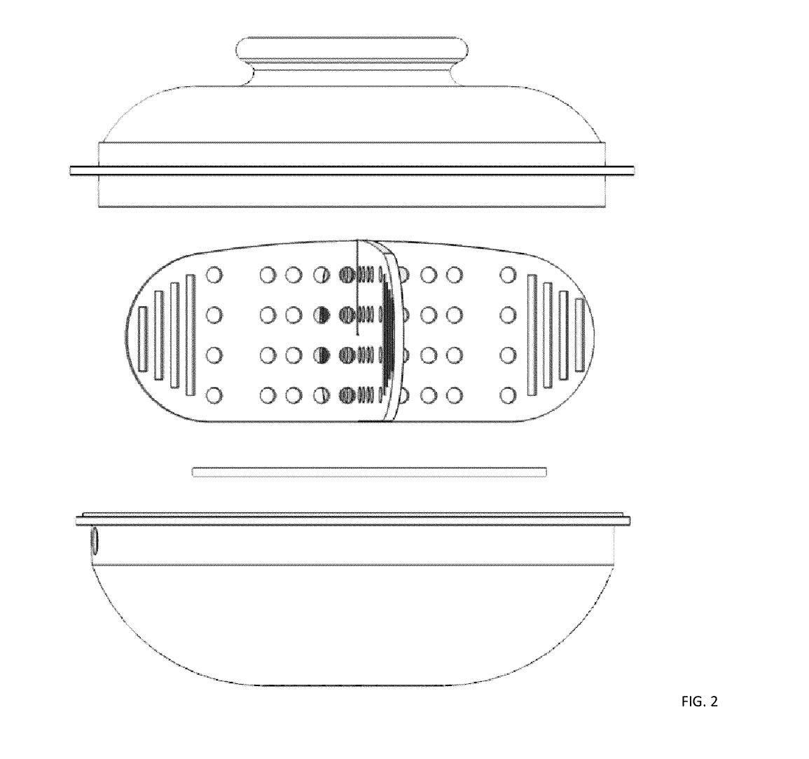

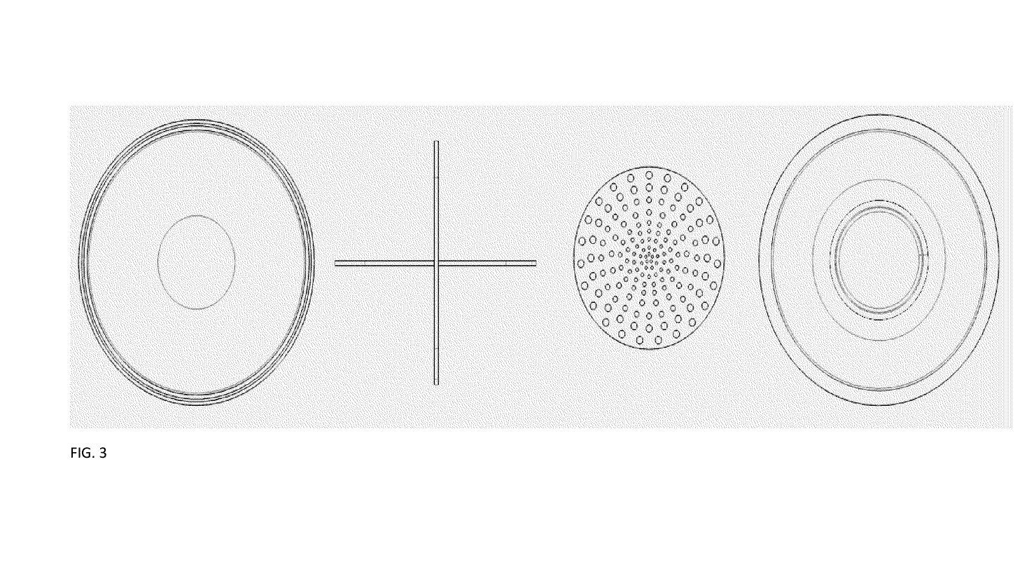

FIG. 1 shows an exploded perspective view of a food washing system, FIG. 2 shows an exploded side view of a food washing system, and FIG. 3 shows an exploded top view of a food washing system. The figures together show components of a foodstuff cleaning device or bowl 20 to wash and display foodstuff such as fruit or vegetable. The bowl 20 includes a curved lid 24 with a barrel shaped handle 26 on the center portion thereof. The lid 24 can be used as a serve dish to display fruits or vegetables thereon when it is detached from the bowl 20. In this configuration, the lid 24 rests above the handle 26 which sits above a table or flat surface.

The bowl 20 has a circular bottom with a curved side 36 that gradually enlarges the volume from a bowl bottom 40 diameter to a bowl edge 32 diameter. The bowl has a plurality of vertical blades 46-48 dividing the bowl into a plurality of chambers, each blade having a plurality of circular openings 48 near the center of the bowl and elongated openings 50 proximal to a bowl wall. In one embodiment, the blades 46-48 from a cross-shape or X-shape that divides the internal chamber of the bowl 20 into 4 sections. The blades 46-48 rest above a cylindrical screen 42 whose diameter is larger than the bowl bottom diameter. In one embodiment, the bowl has a circular bottom with a bottom diameter smaller than the circular screen diameter, wherein the vertical blades comprises two vertical blades dividing the bowl into four chambers and wherein the bottom of the vertical blades approximately fit the circular screen diameter. The vertical blades can press-fit against each other at the center to form an X-shape or a perpendicular shape when assembled.

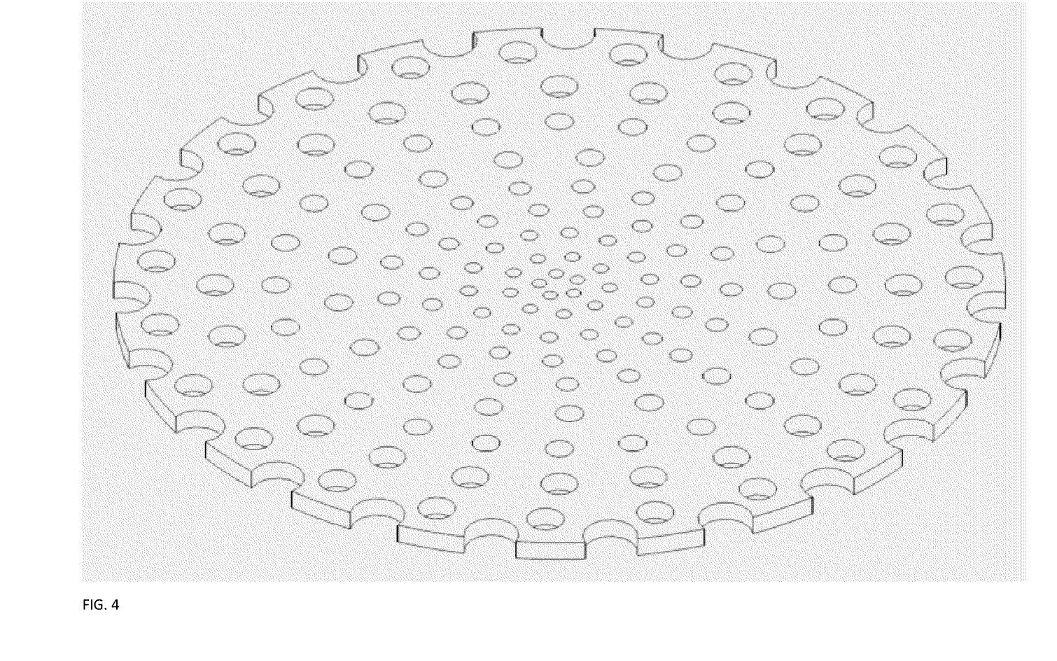

FIG. 4 shows another exemplary perforated bottom screen. The circular screen may be positioned within the bowl 20 in a manner which minimizes the contact between the respective bases and sidewalls of each of these shells. The screen 42 may have a limited number of dimples or other supportive geometries. For example, screen 42 may be provided with about ten spaced dimples in order to provide broad structural support to the bowl 20 while minimizing the area of actual contact between the food stuff and solution.

The bowl 20 has openings 34 on a part of a bowl edge 32 and correspondingly, the lid 24 has a recessed edge 28 with openings 30 thereon. The lid recessed edge 28 can be inserted into the bowl edge 32. In one embodiment, the lid recessed edge is press-fitted into said bowl edge. The openings 30 and 34 operate in a mutually exclusive manner where they keep a cleaning solution such as water inside the bowl 20 during washing, and a mutually inclusive manner where the cleaning solution can be drained away from the bowl 20. The lid recessed edge openings 30 and the bowl edge openings 34 have a first mode exclusive of each other to form a leak proof enclosure to shake the fruit or vegetable and a second mode inclusive of each other to allow liquid to be drained away from said bowl. The circular screen 42 is positioned above the bowl bottom 40 and below the vertical blades 46-48 to keep liquid away from the fruit or vegetable. These components are advantageously separately formed in a manner which permits quick assembly, either manually or mechanically, as well as rapid disassembly for separate cleaning and/or recycling operations.

In operation, fruit or vegetable to be cleaned is loaded in the bowl 20 above the screen 42 and between the blades 46-48. The cleaning device of FIG. 1 is put under a fountain to continuously feed cleaning water into the cleaning device. For washing, the user rotates the lid 24 into the mutually exclusive position where openings 30 and 34 are in opposite positions on the rim 32. The user can then drive the bowl 20 by rotating the entire assembly by hand. This sets the cleaning water moving by means of openings or baffles 44 and 50 on the inner side wall of the bowl 20. The openings 44 and 50 swirls the cleaning water thus the cleaning water rinses and thereby cleans the fruit or vegetable (not shown) in the bowl 201n one embodiment, about 50% to 60% of the interior of the cleaning device is maintained for a full rinse to the raw material to be cleaned. For draining, the user rotates the lid 24 into the mutually inclusive position where openings 30 and 34 are in alignment on the rim 32. After cleaning is complete, the cover 24 is removed. Then the lid is removed from the bowl 20 to unload the raw material already cleaned. In one embodiment, the user can remove the lid or cover 24 and display the vegetable or fruit for consumption without touching the edible items at all, thus contributing to cleanliness. The cleaning device should be thoroughly cleaned with warm soapy water after every use.

For Leafy Greens:
Wash hands with hot soapy water before and after preparing food.
Clean the counter top, cutting boards, and utensils after peeling produce and before cutting and chopping. Bacteria from the outside of raw produce can be transferred to the inside when it is cut or peeled. Wash kitchen surfaces and utensils with hot, soapy water after preparing each food item
Leafy greens from the farmers market, grocery store, farm or garden should be stored at 35-40° F. within two hours of harvesting or purchasing.
Wash greens by separating leaves and soaking them in a bowl of cool water for a few minutes.
Produce with a lot of nooks and crannies like cauliflower, broccoli or lettuce should be soaked for 1 to 2 minutes in cold clean water.
Drain the greens and repeat this process to dilute dirt and contaminants.
Leave leafy green or vegetable to dry via air convection.

For Fruits:
Wash hands with hot soapy water before and after preparing food.
Wash fruits by soaking them in a bowl of cool water for a few minutes.
Drain the water and repeat this process to dilute dirt and contaminants.
Leave fruit to dry via air convection.

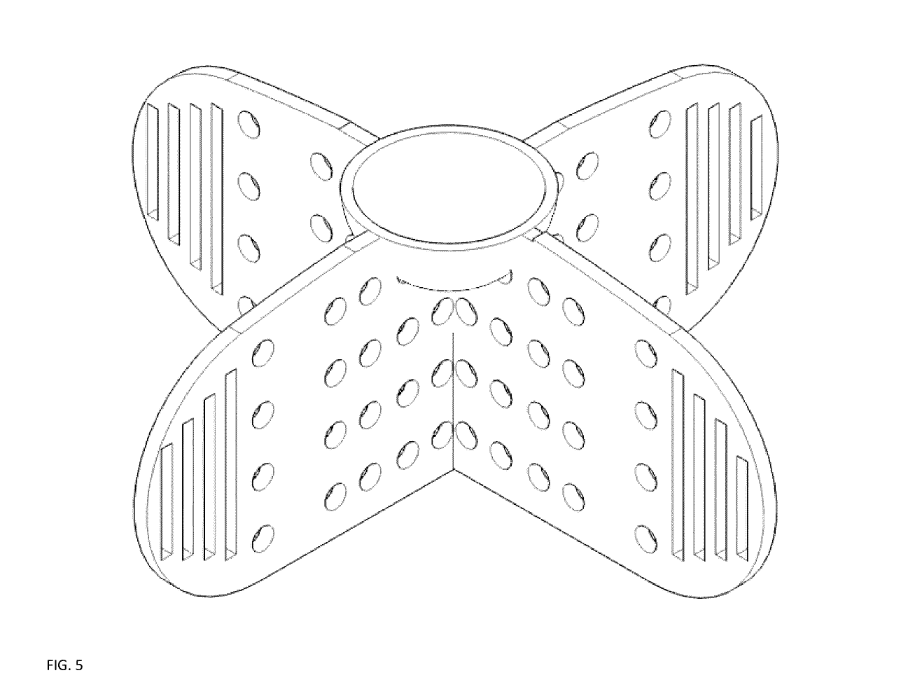

FIG. 5 shows an exemplary bowl chamber divider or separator with a removable bowl on top. In this embodiment, the vertical blades divides the bowl into a plurality of chambers, each blade having a plurality of circular openings near the center of the bowl and elongated openings proximal to a bowl wall. In one embodiment, the blades form a cross-shape or X-shape that divides the internal chamber of the bowl 20 into 4 sections. The blades rest above a cylindrical screen whose diameter is larger than the bowl bottom diameter. In the embodiment of FIG. 5, each blade has curved arc at the end that is not facing the bowl bottom diameter so that when positioned with the other blade, the arcs form at the top a recessed volume that support a removable for fixed display bowl on top. In one embodiment, the recessed volume is half of a ball shape. The display bowl may fit snugly into the recessed volume, or may be smaller or larger. In another embodiment, the display bowl may have drainage openings to allow water to pass through into the bottom of the main bowl. The display bowl on top of the vertical blades can be used for yogurt, cheese or any kind of dip in the bowl.

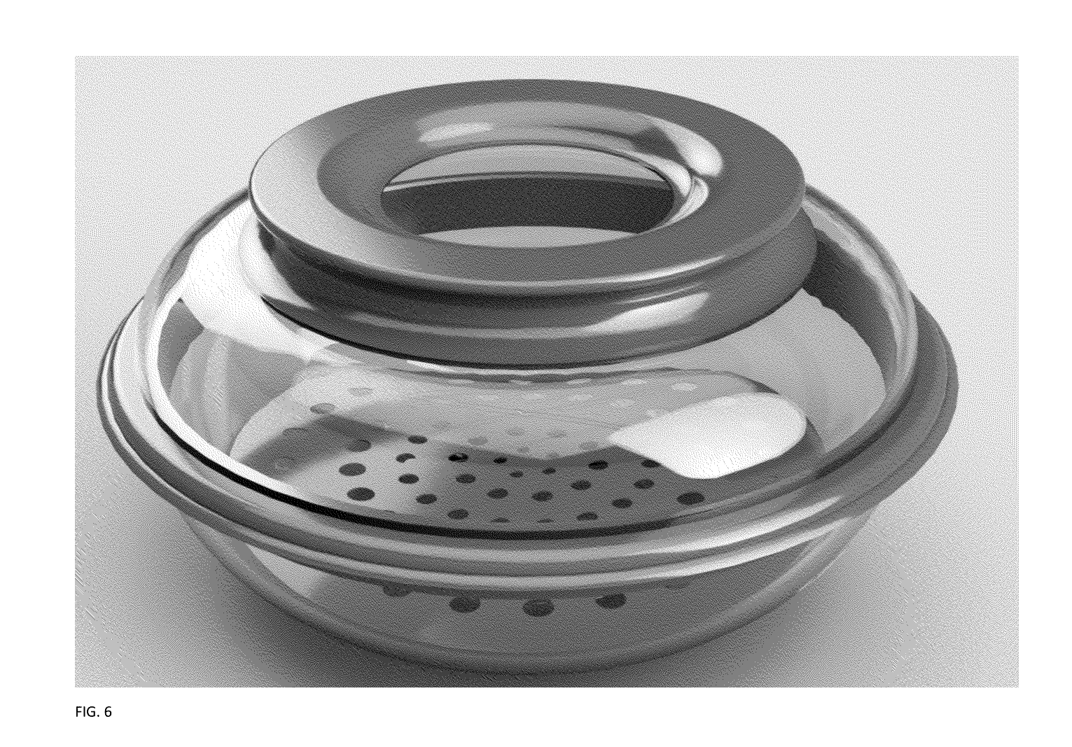

FIG. 6 shows an exemplary see-through food washing system. In the illustrated embodiment, at least the bowl 20 and lid 24 are most preferably formed of a clear, translucent polymer in order to facilitate continuous inspection of the contained foodstuff. In this embodiment, the handle and rim/edge portions and the bottom screen are made of colored material, while the rest of the bowl and lid are clear to show the fruits or vegetables as they are being washed and dried.

In one embodiment, the lid, bowl, vertical blades, and circular screen are microwave safe material. Thus, the bowl and lid can be heated by a microwave oven while cooking a vegetable through steaming. Each component associated with the bowl 20 may be formed of any microwavable material which is rigid enough to support the weight of the foodstuff, and is preferably formed of a crystallized polyester, polypropylene or copolymers thereof. Other suitable materials include styrene maleic anhydride, talc filled polypropylene, high melt strength polypropylene, high crystallinity polypropylene, polyphenylene oxide blended with polystyrene of high impact polystyrene, blends and copolymers thereof including foamed or solid sheets thereof. As used herein with respect to the inner shell, the term “heat resistant” indicates that the inner shell will maintain its structural integrity even when contacted by a foodstuff heated to a temperature of about 200-250 DEG F. If the manufacturer does not require a product that enables visibility of the foodstuff, a more economical foamed polystyrene may be utilized. Other suitable polymeric materials include high impact polystyrene, amorphous polyester, polyvinyl chloride, polyethylene, blends and copolymers thereof.

The bowl can be decorated to be used at a dining table. For example, a decorative image can be printed on an outer side of the bowl or a decal secured to an outer side of the bowl. In one embodiment, a transfer-printed layer is formed by transferring a printing image of any pattern to the surface of a primer layer. For the transfer-printed layer, there is used a transfer sheet obtained by pre-printing an image on a substrate such as polyester film, etc., by gravure printing method. For example, the transfer-printed layer can be formed by bringing the printed surface of the transfer sheet into thermal contact with the surface of the primer layer under pressure. An ink containing, as a binder, at least one selected from a vinyl chloride-vinyl acetate copolymer, polyvinyl chloride, polyvinylidenechloride, polyvinylacetete, acrylic resin, rubber chloride and cyclized rubber is usable for the above printing on the transfer sheet. The transfer-printed layer is formed by pressing a printing image of the ink under heat and the cured resin layer is formed in order to reinforce the transfer-printed layer and improve durability of the decorative plate.

In yet other embodiments, the bottom screen can be press-fit or snap-fit into a receptacle on the bowl 20. The bowl 20 and lid 24 can also be snap-fit together to form a water-tight seal. The bowl body can have protrusions that provide improve gripping of the handle during the shaking and cleaning operation. The side of the bowl can have a grip surface where the grip create a “drag” on the gripping hand, so that when the grip is securely gripped, and torsion is thereafter applied to the grip by use of the object to which the grip is attached, as occurs when shaking and cleaning food in the bowl, for example, the drag resists the torsion and also prevents the grip from slipping from the hand along the axis direction. With light gripping hand pressure. In other embodiments, the bowl 20 has a surface that has been sanded for improved grips. In other embodiments, the openings can be on the lid, and the lid has a knob that is rotatable to move the openings into the mutually exclusive mode for washing or mutually inclusive mode for draining.

While the present invention is described herein as a container particularly adapted for foodstuffs, those skilled in the art will appreciate that the benefits of the present invention may be applicable for the microwaving of other products. It will be appreciated, of course, that although some particular embodiment of the present invention has been shown and described, modifications may be made. It is intended in the following claims to cover all modifications which fall within the scope of the invention.

1. A fruit or vegetable cleaning device comprising a lid and a bowl, comprising:
said bowl comprising a plurality of vertical blades dividing the bowl into a plurality of chambers, each blade having a plurality of circular openings near the center of the bowl and elongated openings proximal to a bowl wall; and
said bowl having openings on a part of a bowl edge and said lid having a recessed edge with openings thereon, said lid recessed edge adapted to be inserted into said bowl edge, said lid recessed edge openings and said bowl edge openings having a first mode exclusive of the lid recessed edge openings and said bowl edge openings to form a leak proof enclosure to shake fruit or vegetable and a second mode inclusive of the lid recessed edge openings and said bowl edge openings to allow liquid to be drained away from said bowl; and
a circular screen positioned below said vertical blades and wherein each blade has curved arc at an end opposite a bowl bottom and all arcs form at a bowl top a recessed volume that supports a display bowl on the bowl top.

2. The cleaning device of claim 1, wherein the lid, bowl, vertical blades, and circular screen comprises microwave safe material and wherein the bowl and lid are positioned inside a microwave oven while cooking a vegetable through steaming.

3. The cleaning device of claim 1, wherein the display bowl on top of the vertical blades comprises drainage openings to allow water to pass through.

4. The cleaning device of claim 1, wherein said lid recessed edge is press-fitted into said bowl edge.

5. The cleaning device of claim 1, comprising an image printed on an outer side of the bowl or a decal secured to an outer side of the bowl.

6. The cleaning device of claim 1, wherein said lid comprises a barrel shaped handle on the center portion thereof.

7. The cleaning device of claim 1, wherein the bowl has a circular bottom with a bottom diameter smaller than a circular screen diameter, wherein the vertical blades comprises two vertical blades dividing the bowl into four chambers and wherein the bottoms of the vertical blades approximately fit the circular screen diameter.

8. The cleaning device of claim 1, wherein the bowl comprises a bowl lip and the lid comprises a lid ledge adapted to contact the bowl lip to secure fruit or vegetable inside the bowl.

9. The cleaning device of claim 1, wherein said vertical blades press-fit against each other at the center to form an X-shape or a perpendicular shape when assembled.

10. The cleaning device of claim 1, wherein the bowl is decorated to be used at a dining table.

11. A method for cleaning fruit or vegetable cleaning, comprising:
inserting a plurality of vertical blades dividing a bowl into a plurality of chambers, each blade having a plurality of circular openings near the center of the bowl and elongated openings proximal to a bowl wall;
positioning a circular screen below said vertical blades; and
inserting a lid recessed edge inserted into a bowl edge in a first mode exclusive of each other to form a leak proof enclosure to shake the fruit or vegetable and a second mode inclusive of each other to allow liquid to be drained away from the bowl.

12. The method of claim 11, wherein the lid, bowl, vertical blades, and circular screen comprises microwave safe material.

13. The method of claim 12, wherein the bowl and lid are heated by a microwave oven while cooking a vegetable through steaming.

14. The method of claim 11, comprising press-fitting said lid recessed edge into said bowl edge.

15. The cleaning device of claim 1, comprising printing an image on an outer side of the bowl or a decal secured to an outer side of the bowl.

16. The cleaning device of claim 1, wherein said lid comprises a barrel shaped handle on the center portion thereof, comprising holding the barrel and rotating the lid to wash or to remove water from an interior.

17. The cleaning device of claim 1, wherein the bowl has a circular bottom with a bottom diameter smaller than a circular screen diameter, wherein the vertical blades comprises two vertical blades dividing the bowl into four chambers and wherein the bottoms of the vertical blades approximately fit the circular screen diameter, comprising placing fruit or vegetable in one or more chambers.

18. The cleaning device of claim 1, wherein the bowl comprises a bowl lip and the lid comprises a lid ledge adapted to contact the bowl lip to secure fruit or vegetable inside the bowl.

19. The cleaning device of claim 1, wherein said vertical blades press-fit against each other at the center to form an X-shape or a perpendicular shape when assembled.

20. The cleaning device of claim 1, comprising decorating the bowl for a dining table.
